(19) United States
(12) Patent Application Publication
(10) Pub. No.: US 2017/0211988 A1
(43) Pub. Date: Jul. 27, 2017

(54) DEVICE FOR MOUNTING TEMPERATURE SENSOR FOR MOTOR

(71) Applicant: Hyundai Motor Company, Seoul (KR)

(72) Inventors: Yong Sung Jang, Hwaseong (KR); Ji Yeon Kim, Gangwon-do (KR); Myung Gyu Kim, Seoul (KR)

(21) Appl. No.: 15/215,767

(22) Filed: Jul. 21, 2016

(30) Foreign Application Priority Data
Jan. 25, 2016 (KR) 10-2016-0008463

(51) Int. Cl. G01K 1/14

(52) U.S. Cl. CPC G01K 1/14

(57) ABSTRACT

A device for mounting a temperature sensor for a motor is provided. The device is replaceably mounted at a predetermined position of a motor and allows a temperature to be more easily detected when heat is generated as the motor operates. The device is configured to allow a temperature sensor to more smoothly perform a sensing function and allows improved replacement of the temperature sensor upon malfunction of the temperature sensor breaks down. The device includes a structure with the temperature sensor disposed in a temperature sensor fixing bracket, and a thermally conductive substance is received and sealed between the temperature sensor fixing bracket and the temperature sensor. The temperature sensor is detachably coupled to an end coil of a motor.

### CROSS-REFERENCE TO RELATED APPLICATION

This application claims under 35 U.S.C. §119(a) the benefit of Korean Patent Application No. 10-2016-0008463 filed on Jan. 25, 2016, the entire contents of which are incorporated herein by reference.

### BACKGROUND

(a) Technical Field

The present disclosure relates to a device for mounting a temperature sensor for a motor and more particularly, to a device for mounting a temperature sensor for a motor, replaceably mounted at a predetermined position of a motor and allows a temperature to be more easily detected when heat is generated as the motor operates.

(b) Background Art

Typically, an environmentally-friendly vehicle (e.g., a hybrid automobile, an electric automobile, a fuel cell vehicle, etc.) is equipped with a motor configured to drive the vehicle and generate electric power. In particular, heat that is proportional to the square of electric current, is generated in a stator coil when the electric current is applied to the stator coil during operation of the motor, and the heat is transferred to a stator and the like adjacent to the stator coil. When the motor operates over a long period of time, the stator and components at the periphery of the stator are overheated. Accordingly the operational efficiency of the motor is degraded, and a separate cooling system is mounted on the motor. As a preceding process for operating the cooling system of the motor, a step of mounting a temperature sensor in the motor and measuring a temperature of the motor is performed.

Referring to the attached FIG. 1, of the related art a temperature sensor 10 is mounted adjacent to a stator coil 12 of the motor and the like, and mounted at a portion of the stator coil (e.g., at a lower side of an end coil) where a temperature reaches a greatest value. Therefore, the temperature sensor 10 detects a temperature of the motor, and a signal detecting the temperature is transmitted to a motor controller 14 and used to determine whether to cool the motor.

However, a structure for mounting a temperature sensor on the motor in the related art has the following problems. First, wiring lines such as wires, which are used to start the vehicle, are also used as wiring lines for the temperature sensor. Accordingly, the temperature sensor is damaged (e.g., burnt out) when a disconnection and a contact defect of the wiring line occur. Second, the temperature sensor is mounted on the motor without a separate protection element, and mounted adjacent to the end coil of the stator coil to provide advantageous temperature sensing. As a result, when the temperature sensor breaks down, or malfunctions maintenance limited to the replacement of the temperature sensor cannot be performed. In particular the entirety of the motor needs to be replaced when the temperature sensor malfunctions.

The above information disclosed in this section is merely for enhancement of understanding of the background of the invention and therefore it may contain information that does not form the prior art that is already known in this country to a person of ordinary skill in the art.

### SUMMARY

The present invention provides a device for mounting a temperature sensor for a motor that allows a temperature sensor to more smoothly perform a sensing function and improves the ease of replacement of the temperature sensor when the temperature sensor malfunctions. In particular, the device may be manufactured in a structure with the temperature sensor disposed in a temperature sensor fixing bracket. A thermally conductive substance may be disposed and sealed between the temperature sensor fixing bracket and the temperature sensor, and to allow the temperature sensor to be detachably coupled to an end coil of a motor.

In one aspect, the present invention provides a device for mounting a temperature sensor for a motor that may include a temperature sensor fixing bracket with a structure having an bore at one side thereof, and may be coupled to an end coil of a motor, a temperature sensor may be separably disposed within the temperature sensor fixing bracket, a thermally conductive substance may be disposed within the temperature sensor fixing bracket and a cap may be separably fastened and sealed to the bore of the temperature sensor fixing bracket.

In an exemplary embodiment, internal threads may be formed in the bore of the temperature sensor fixing bracket, and external threads may be formed at one side of the cap to separably fastened the cap to the bore of the temperature sensor fixing bracket. In addition, a fluid tight O-ring may be inserted into a fastening interface and may be disposed between the cap and the temperature sensor fixing bracket. An aperture for a wiring line that extends from the temperature sensor to a motor controller may be formed in the cap.

In another exemplary embodiment, seating fasteners, mounted on the end coil of the motor, may be integrally formed at a plurality of opposite sides of the temperature sensor fixing bracket. A seating groove that seats the temperature sensor fixing bracket may be formed in the end coil of the motor. The thermally conductive substance may be selected from thermally conductive oil or thermal grease.

### BRIEF DESCRIPTION OF THE DRAWINGS

The above and other features of the present invention will now be described in detail with reference to exemplary embodiments thereof illustrated in the accompanying drawings which are given hereinbelow by way of illustration only, and thus are not limitative of the present invention, and wherein:

FIG. 1 is an exemplary schematic view illustrating a position where a temperature sensor of a motor is mounted according to the related art;

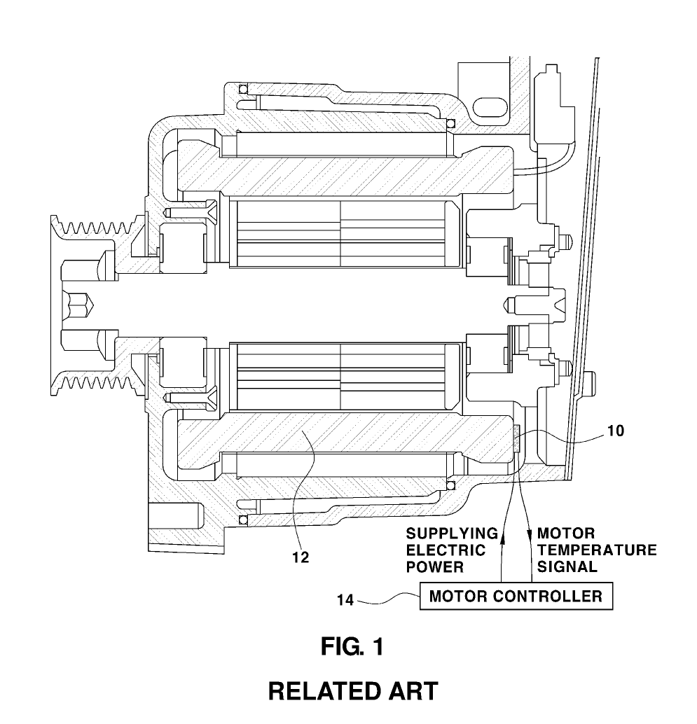

FIG. 2 is an exemplary cross-sectional view illustrating states before and after a device for mounting a temperature sensor for a motor according to an exemplary embodiment of the present invention is assembled; and

FIGS. 3A-3B are exemplary views illustrating a state in which the device for mounting a temperature sensor for a motor according to an exemplary embodiment of the present invention is mounted on the motor.

Reference numerals set forth in the Drawings includes reference to the following elements as further discussed below:
10: temperature sensor
10-1: sensing circuit unit
10-2: wiring line
12: stator coil
14: motor controller
16: end coil
20: temperature sensor fixing bracket
21: bore
22: internal threads
23: cap
24: aperture
25: external threads
26: thermally conductive substance
27: O-ring
28: seating fastener
30: end coil
31: seating groove

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below. The terminology used herein is for the purpose of describing particular embodiments only and is not intended to be limiting of the invention. As used herein, the singular forms “a”, “an” and “the” are intended to include the plural forms as well, unless the context clearly indicates otherwise.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Hereinafter, exemplary embodiments of the present invention will be described in detail with reference to the accompanying drawings.

A temperature sensor configured to detect a motor temperature may be mounted on a motor disposed in an environmentally-friendly vehicle. For example, when a sensing temperature of the temperature sensor is a reference temperature or greater, a temperature sensor warning lamp associated with the motor may be turned on. Even in response to determining a failure of the temperature sensor breaks down after an inspection of a vehicle, the temperature sensor may not be replaced in the related art. Accordingly, the entirety of the motor may need to be replaced and the maintenance costs and time required for replacement increase. To solve the aforementioned problems, the present invention allows the temperature sensor to more smoothly perform a sensing function and allows an improved ease of replacement of the temperature sensor upon malfunction of the temperature sensor.

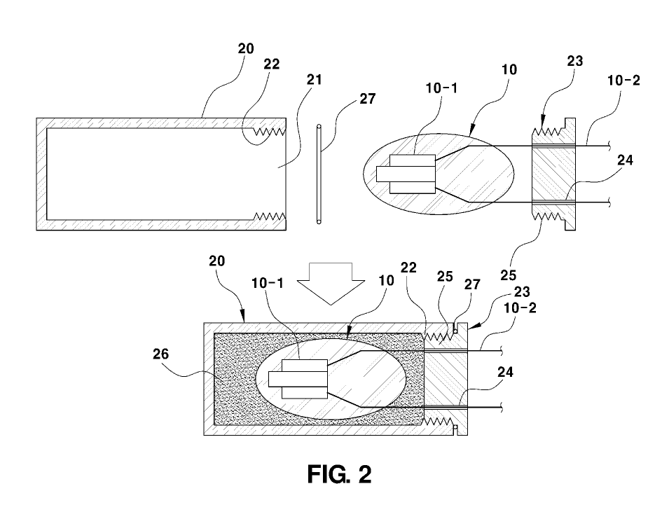

The attached FIG. 2 is an exemplary cross-sectional view illustrating states before and after a device for mounting a temperature sensor for a motor according to the present invention is assembled. In FIG. 2, reference numeral 20 may indicated a temperature sensor fixing bracket. The temperature sensor fixing bracket 20 may be formed from a thermally conductive metallic material (e.g., copper identical to a material of an end coil), an bore 21 may be formed at one side of the temperature sensor fixing bracket 20, and internal threads 22 may be formed on an interior circumferential surface of the bore 21.

A temperature sensor 10 may be disposed within the temperature sensor fixing bracket 20, which is assembled as above, in a protectable manner. The temperature sensor 10 may include a sensing circuit unit 10-1, and a wiring line 10-2 which extends from the sensing circuit unit 10-1 to a motor controller. For example, the wiring line 10-2 of the temperature sensor 10 may be fitted into a cap 23.

The cap 23 may be formed from of a thermally conductive metallic material like the temperature sensor fixing bracket 20, and may have a structure in which apertures 24 through which the wiring line 10-2 passes are penetratively formed within the cap 23, and external threads 25 may be formed at one side of the cap 23. Therefore, as the external threads 25 of the cap 23 are thread-fastened to the internal threads 22 of the temperature sensor fixing bracket 20, the interior of the temperature sensor fixing bracket 20 with the temperature sensor 10 disposed therein may be sealed.

Moreover, the interior of the temperature sensor fixing bracket 20 may be filled with a thermally conductive substance 26 prior to fastening the cap 23 to the temperature sensor fixing bracket 20. In particular, the thermally conductive substance 26 protect the temperature sensor 10, and may be configured to transfer heat from the motor to the temperature sensor 10. For example, thermally conductive oil or thermal grease having excellent thermal conductivity may be used as the thermally conductive substance 26, and any material may be used other than these materials provided the material may transfer heat to the temperature sensor.

Further, a process of assembling the device for mounting a temperature sensor for a motor according to the present invention, which includes the aforementioned configurations, will be described below. First, the temperature sensor 10 may be inserted into the temperature sensor fixing bracket 20. Then, the interior of the temperature sensor fixing bracket 20 may be filled with the thermally conductive substance 26. For example, the temperature sensor 10 may be surrounded and protected by the thermally conductive substance 26. Subsequently, as the external threads 25 of the cap 23 are thread-fastened to the internal threads 22 of the temperature sensor fixing bracket 20, the interior of the temperature sensor fixing bracket 20 with the temperature sensor 10 and the thermally conductive substance 26 disposed therein may be sealed.

Particularly, a fluid tight O-ring 27 may be inserted at a fastening interface disposed between the cap 23 and the temperature sensor fixing bracket 20, and a fluid tight element (e.g., an O-ring) may be disposed within the apertures 24 of the cap 23 through which the wiring line 10-2 passes, to seal the interior of the temperature sensor fixing bracket 20. Subsequently, the temperature sensor fixing bracket 20 with the temperature sensor 10 and the thermally conductive substance 26 disposed therein may be mounted at a position to sense a temperature of the motor.

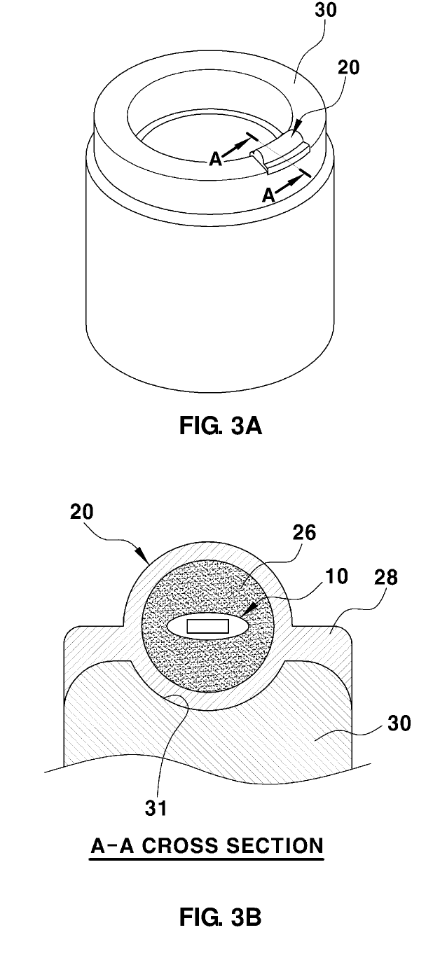

The attached FIGS. 3A and 3B are an exemplary views illustrating an operational condition where the device for mounting a temperature sensor for a motor according to the present invention may be mounted on the motor. As illustrated in FIGS. 3A and 3B, the temperature sensor fixing bracket 20 may be mounted at a position to sense a temperature of the motor, for example, an end coil 30 position on an end portion of a stator coil of the motor. In particular, a seating groove 31 with the cylindrical temperature sensor fixing bracket 20 disposed therein and seated may be formed on a surface of the end coil 30, and a plurality of opposite surfaces of the seating groove 31 may formed to be inclined toward the exterior.

Seating fasteners 28, may be tightly coupled to and mounted on the surface of the end coil 30 of the motor, may integrally protrude at a plurality of opposite sides (e.g., two) of the temperature sensor fixing bracket 20. Therefore, the cylindrical temperature sensor fixing bracket 20 may be inserted and seated within the seating groove 31 of the end coil 30, and the seating fasteners 28 may be tightly coupled to the inclined surfaces at the plurality of opposite sides of the seating groove 31. Particularly, thermally conductive adhesives may be disposed between the temperature sensor fixing bracket 20 and the seating groove 31 and between the seating fastener 28. The inclined surfaces at the plurality of opposite sides of the seating groove 31, or the seating fasteners 28 may be coupled via metallic pieces, to the inclined surfaces at the plurality of opposite sides of the seating groove 31, and the temperature sensor fixing bracket 20 may be coupled to the end coil 30.

In particular, when the temperature sensor fixing bracket 20 are inserted and seated in the seating groove 31 of the end coil 30, and the seating fasteners 28 are tightly coupled to the inclined surfaces at the plurality of opposite sides of the seating groove 31, a contact area of the temperature sensor fixing bracket 20 may be maximized with respect to the end coil 30, and may obtain a high heat transfer effect from the motor by maximization of the contact area. Therefore, heat generated by the operation of the motor, in particular, heat generated from the end coil 30 may be transferred to the temperature sensor 10 by the temperature sensor fixing bracket 20 and the thermally conductive substance 26 in the temperature sensor fixing bracket 20. Namely, the temperature sensing may be performed by the temperature sensor 10, and a sensed signal may be transmitted to the motor controller via the wiring line, and may provide the logic to determine when to cool the motor.

Moreover, when the temperature sensor 10 malfunctions, the cap 23 may be released from the temperature sensor fixing bracket 20, and the temperature sensor 10 may be detached from the interior of the temperature sensor fixing bracket 20. Accordingly, a new temperature sensor 10 may be more easily installed to improve the maintenance properties required to replace a temperature sensor component.

Through the aforementioned technical solutions, the present invention provides the effects below.

First, since the temperature sensor is positioned in the separate temperature sensor fixing bracket, the temperature sensor may be protected from external force and vibration, and robust durability and stability of the temperature sensor may be provided.

Second, since of the temperature sensor fixing bracket and the thermally conductive substance may be received in the temperature sensor fixing bracket, it may be possible to maintain a temperature sensing function proper to the temperature sensor.

Third, when the temperature sensor malfunctions, since the temperature sensor may be separated from the temperature sensor fixing bracket, and then replaced by a new one, it may be possible to improve maintenance properties of the temperature sensor, and to reduce maintenance costs by preventing the entirety of the motor from being replaced like the related art when the temperature sensor breaks down.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalent.

What is claimed is:

1. A device for mounting a temperature sensor for a motor, comprising:
a temperature sensor fixing bracket with a structure having a bore at one side thereof, and is coupled to an end coil of a motor;
a temperature sensor separably disposed in the temperature sensor fixing bracket;
a thermally conductive substance disposed in the temperature sensor fixing bracket; and
a cap separably fastened and sealed to the bore of the temperature sensor fixing bracket.

2. The device of claim 1, wherein internal threads are formed in the bore of the temperature sensor fixing bracket, and external threads are formed at one side of the cap to separably fasten the cap to the bore of the temperature sensor fixing bracket.

3. The device of claim 1, wherein a fluid tight O-ring is inserted into a fastening interface disposed between the cap and the temperature sensor fixing bracket.

4. The device of claim 1, wherein an aperture for a wiring line that extends from the temperature sensor to a motor controller is formed within the cap.

5. The device of claim 1, wherein seating fasteners, mounted on the end coil of the motor are integrally formed at a plurality of opposite sides of the temperature sensor fixing bracket.

6. The device of claim 5, wherein the temperature sensor fixing bracket is disposed on a seating groove to increase a contact area, that is formed in the end coil of the motor.

7. The device of claim 1, wherein the thermally conductive substance is selected from thermally conductive oil or thermal grease.
